(19) United States
(12) Patent Application Publication
(10) Pub. No.: US 2014/0078042 A1
(43) Pub. Date: Mar. 20, 2014

(54) ELECTRONIC DEVICE AND THE CONTROLLING METHOD THEREOF

(71) Applicant: NATIONAL TAIWAN UNIVERSITY OF SCIENCE AND TECHNOLOGY, Taipei City (TW)

(72) Inventors: Jia-Jun Lu, Taipei City (TW); Mu-De Wang, Taipei City (TW); Zong-You Wu, Taipei City (TW); Guo-Huei Hsu, Taipei City (TW)

(73) Assignee: NATIONAL TAIWAN UNIVERSITY OF SCIENCE AND TECHNOLOGY, Taipei City (TW)

(21) Appl. No.: 13/898,322

(22) Filed: May 20, 2013

(30) Foreign Application Priority Data
Sep. 20, 2012 (TW) 101134383

(51) Int. Cl. G06F 3/03

(52) U.S. Cl. CPC G06F 3/03
USPC 345/156

(57) ABSTRACT

The present invention discloses an electronic device and the controlling method thereof. More specifically, the device and method of the present invention are capable of providing a pre-determined function in a pre-determined situation by inputting and comparing an accelerating data generated by an acceleration sensor. Thus, the present invention allows the user to define a three-dimensional action path as the trigger requirement of a pre-determined function. Accordingly, the user is capable of applying the electronic device with more flexibility and less limitation thereof.

### PRIORITY CLAIM

This application claims the benefit of the filing date of Taiwan Patent Application No. 101134383, filed Sep. 20, 2012, entitled “AN ELECTRONIC DEVICE AND THE CONTROLLING METHOD THEREOF,” and the contents of which is hereby incorporated by reference in its entirety.

### FIELD OF THE INVENTION

The present invention discloses an electronic device and the controlling method thereof, more specifically; the present invention allows users to define a customized three dimensional action as an activation command of a pre-determined function of the electronic device.

### BACKGROUND OF THE INVENTION

A touch screen is an electronic visual display that can detect the presence and location of a touch within the display area. The term generally refers to touching the display of the device with a finger or hand. Touch screens can also sense other passive objects, such as a stylus. Touch screens are common in devices such as game consoles, all-in-one computers, tablet computers, and smart phones.

Apart from touch screens, another aspect of electronic device controlling technology is being developed recently, one of the most interesting ones is “shake to unlock” technology, by the orientation sensor installed in the mobile phone, the user may place the mobile phone at several different angles so as to unlock the screen. Based on the shake to unlock technology, an improvement is disclosed by the applicant of the present application.

### SUMMARY OF THE INVENTION

In one aspect of the invention, a controlling method of an electronic device is disclosed. The controlling method of the present invention may essentially be composed of a step S3 to S6. The step S3 refers to a step of automatically obtaining reference data from a memory, the reference data comprising a first acceleration mode having a plurality of acceleration factors, each of the plurality of acceleration factors comprises a plurality of acceleration vector data and a plurality of acceleration dimension data. The step S4 refers to a step of automatically obtaining verifying data from the memory, the verifying data comprises a second acceleration mode having a plurality of acceleration factors, each of the plurality of acceleration factors comprises a plurality of acceleration vector data and a plurality of acceleration dimension data. The step S5 refers to a step of automatically comparing the reference data with the verifying data so as to generate an ON signal. The step S6 refers to a step of automatically activating a functional module 60 in accordance by the ON signal, the functional module 60 has a pre-determined function.

Furthermore, while in actual practice, the method previously described may further comprise steps of S1 to S3. The Step S1 refers to a step of utilizing an acceleration sensor to generate the reference data in accordance with the first acceleration mode applied to the electronic device and storing the reference data to the memory. The Step S2 refers to a step of utilizing an acceleration sensor to generate the verifying data in accordance with the second acceleration mode applied to the electronic device and storing the verifying data to the memory.

Moreover, the reference data and the verifying data may, but not necessarily, comprise a plurality of subsequent orientation factors; each of the plurality of the orientation factors comprises a plurality of orientation vector data and a plurality of orientation dimension data. Furthermore, the pre-determined function previously described may, but not limited to, comprise a user interface U1 unlocking function.

Furthermore, another aspect of the present invention is to provide an electronic device comprising, but not be limited to, a display, an acceleration sensor, a functional module, a memory and a CPU. Moreover, the display is utilized to display a user interface. The acceleration sensor is utilized to sense the acceleration of the electronic device. The functional module is utilized to provide a pre-determined function. The memory is utilized to store an interface data and a verifying procedure data. The interface data comprises a user interface and the verifying procedure data comprises the following steps of: automatically obtaining a reference data, the reference data comprising a first acceleration mode having a plurality of acceleration factors and being generated by the acceleration sensor; automatically obtaining a verifying data, the verifying data comprising a second acceleration mode having a plurality of acceleration factors and being generated by the acceleration sensor; automatically comparing the reference data with the verifying data so as to generate an ON/OFF controlling signal; and automatically activating the pre-determined function in accordance with the ON signal. The CPU is coupled with the display, the acceleration sensor, the functional module and the memory, the CPU is utilized to operate the verifying procedure so as to turn on the functional module while the reference data is matched with the verifying data.

### BRIEF DESCRIPTION OF THE DRAWINGS

The teachings of the present invention can be readily understood by considering the following detailed description in conjunction with the accompanying drawings, in which:

FIG. 1 depicts a schematic figure of a preferred embodiment of the present invention.

FIG. 2 depicts a flow chart diagram of the embodiment of the controlling method of the electrical device.

FIG. 3A to 3D depicts a schematic figure of a preferred embodiment of the present invention.

FIG. 4 depicts a schematic figure of another embodiment of the present invention.

### DETAILED DESCRIPTION

The present invention discloses an electronic device having an acceleration sensor 30 disposed therein and the controlling method thereof. More specifically, the present invention allows the user to define a three dimensional acceleration motion as an activation signal of a pre-determined function.

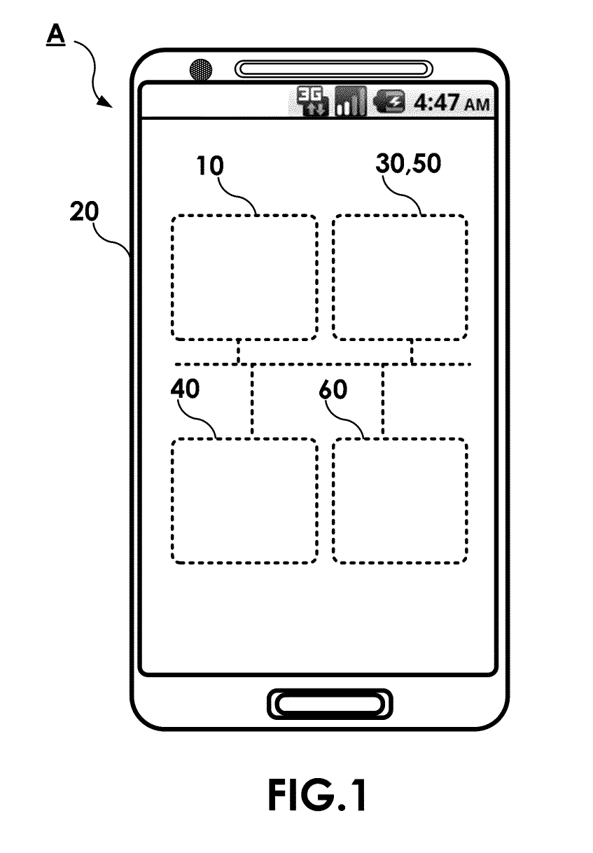

Please refer to FIG. 1, FIG. 1 depicts a schematic figure of a preferred embodiment of the present invention. As shown in the figure, the electronic device A of the present invention is essentially composed of a memory 10, a display 20, an acceleration sensor 30, a CPU 40, an orientation sensor 50 and a functional module 60.

It should be noticed that in the present embodiment, the electronic device A of the present invention may, but not limited to, be a mobile phone, a laptop, notebook, tablet or any other portable electronic device which has an internal acceleration sensor 30 installed therein or an external acceleration sensor 30 connected therewith so as to be capable of detecting the acceleration. Furthermore, the memory 10, the display 20, the acceleration sensor 30, the CPU 40, the orientation sensor 50 and a functional module 60 may either be respectively embedded in the electronic device A of the present invention or be connected by a cable therewith.

The components of the present invention shall be herein described respectively. Firstly, the display 20 of the present invention is capable of displaying a user interface U1 so as to allow the user to input or output commands thereby. As shown in FIG. 1, the display 20 may be a touch panel.

Meanwhile, the acceleration sensor 30 is capable of sensing or detecting acceleration of a certain object by attaching the acceleration sensor 30 on the surface thereof. In the preferred embodiment, the acceleration sensor 30 may be a built-in type electrical accelerometer which is capable of sensing X-Y-Z axial simultaneously so as to generate a plurality of subsequent acceleration factors correspondingly, while each of the acceleration factors may comprise a plurality of acceleration dimension data and acceleration vector data for each axial.

More specifically, the present invention may optionally comprise an orientation sensor 50. The orientation sensor 50 may refer to an electronic component which is capable of detecting the inclination of X-Y-Z axial. More specifically, the orientation sensor 50 of the present invention may, but not limited to, be a semiconductor formed electronic component. It should be noticed that the acceleration sensor 30 of the present invention may be utilized as the orientation sensor 50 for detecting the inclination of the axial, in this situation, the acceleration sensor 30 could be referred as the orientation sensor 50 of the present invention.

Moreover, the CPU 40 of the present invention may, but not limited to, be a silicon based semi-conductor chip having data processing ability, however, the CPU 40 may also refer to any other means which is capable of processing data thereby, such as a PCB having logical circuit formed thereon. More specifically, the present invention may be coupled to all of the other electronic components so as to control the data processing function thereof.

Furthermore, the memory 10 of the present invention refers to a module that is capable of storing signals or data. For example, in the present embodiment, the memory 10 refers to a flash memory. However, the memory 10 of the present invention may also refer to a hard-disk, a RAM or any other data storing means. More specifically, the memory 10 may be disposed into the internal spacing of the electronic device, however, the memory 10 may also be externally disposed and connected to the other modules by a cable or any other remote communication means, such as WI-FI or 3G. In the present embodiment, the memory 10 stores an interface data and a verifying procedure data at the initial state.

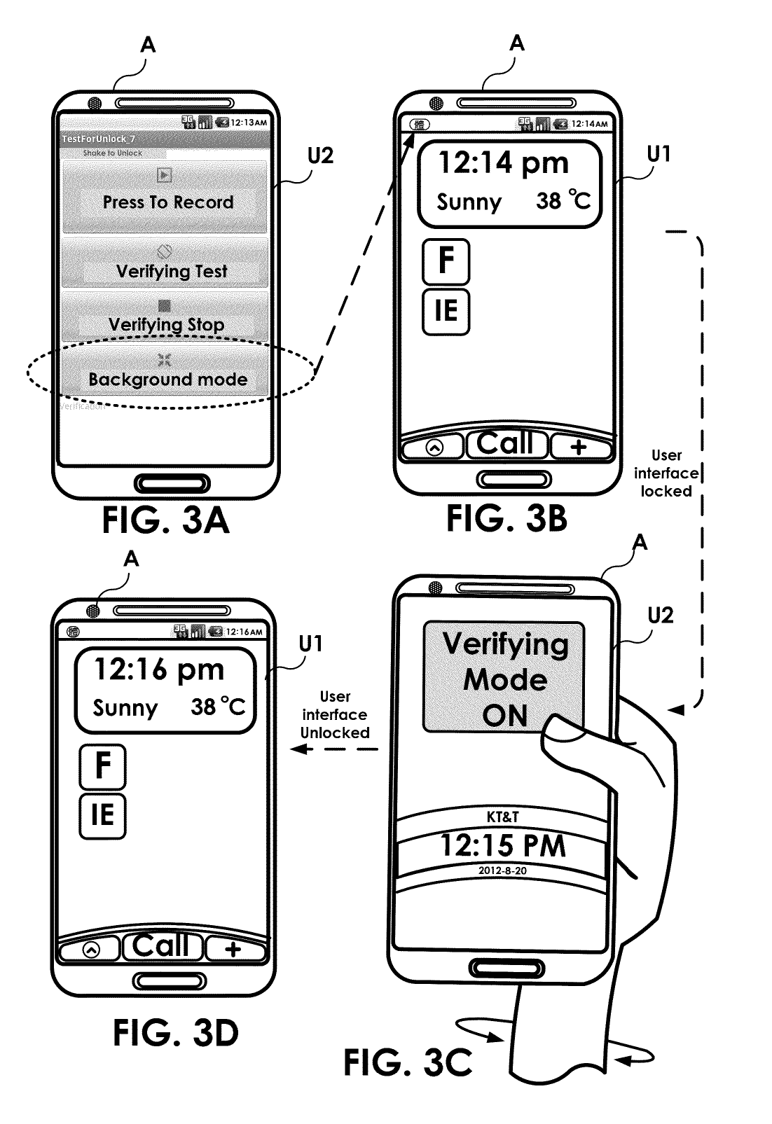

Moreover, in the present invention, the interface data may comprises an operating system such as ANDROID, IOS or WINDOWS which has a corresponding user interface U1 respectively. Furthermore, apart from the operating system, the memory 10 may further comprise a software (also referred to as an APP) operating under the operating system, which has a software interface U2 as depicted in FIG. 3A to FIG. 3D.

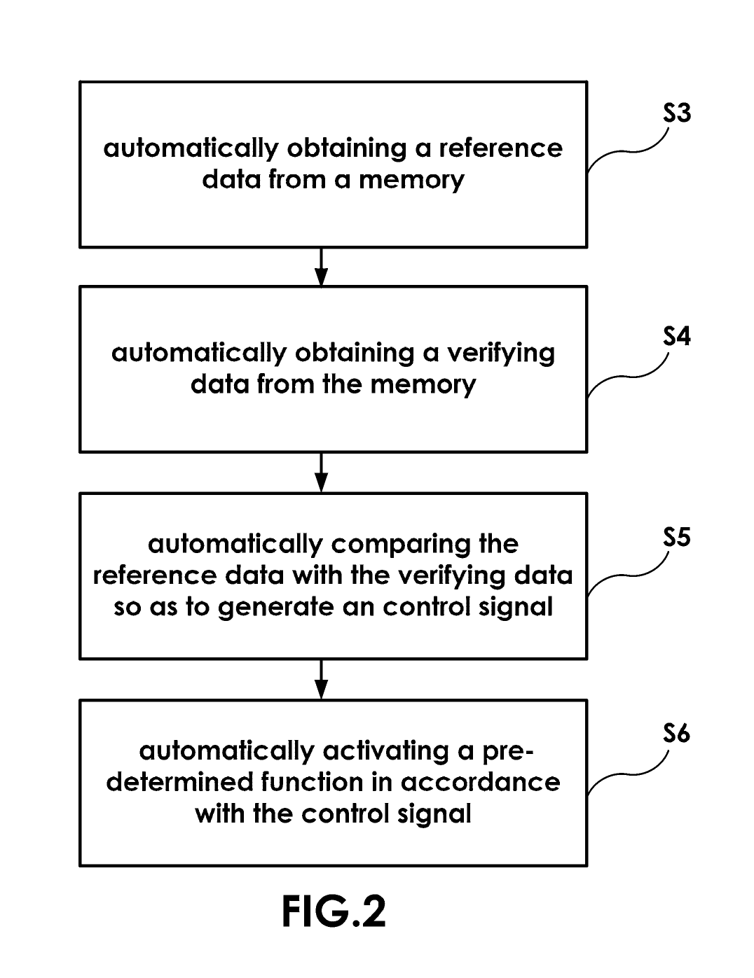

In order to achieve the said function, the memory 10 further comprises a verifying procedure data. The verifying procedure data may comprise a plurality procedures or steps, as depicted in FIG. 2, which comprises the steps of step S3 to step S6. The step S3 refers to automatically obtaining a reference data from a memory. The Step S4 refers to automatically obtaining a verifying data from the memory. The Step S5 refers to automatically comparing the reference data with the verifying data so as to generate a control signal. The Step S6 refers to automatically activating a pre-determined function in accordance with the control signal.

By the said verifying procedure data, the CPU 40 may control the functional module 60 in accordance with the verifying procedure so as to activate the functional module 60 while the reference data matches with the verifying data.

The functional module 60 is utilized to provide a pre-determined function. More specifically, the pre-determined function may include but not be limited to, a function of playing or switching a sound track, taking photo, dialing a pre-determined phone number, unlocking the user interface, sending the coordinate to a pre-determined user, mute, switch on/off the WI-FI or 3G module or any other possible but not mentioned functions which may be executed by a smart phone or the electronic device of the present invention. Importantly, the functional module 60 of the present invention may either be a substantial and independent hardware, a software or procedure.

More specifically, the controlling method of the electronic device is described herein. Please refer to the FIG. 3A to FIG. 3D. By FIG. 3A to FIG. 3D, it is clearly shown that the software interface U2 may briefly be classified into a recording mode as depicted in FIG. 3A, a background mode as depicted in FIG. 3B and a verifying mode as depicted in FIG. 3C in accordance with the condition or function thereof.

While in actual use, the user has to define a reference data, by pressing the “press to record” button display 20 in the software interface U2 without releasing, the software interface U2 may be switched into the recording mode so as to provide a reference data recording function. The reference data recording function is capable of recording a motion of user by sensing or detecting the acceleration and orientation by acceleration sensor 30 and orientation sensor 50 so as to form a reference data as previously described. It should be noticed that the reference data may, but not limited to, be formed of a plurality of subsequent acceleration factors and orientation factors. The reference data shall be stored into the memory 10 for later use after it is generated. It should also be noticed that 3 to 50 acceleration factors and orientation factors may be captured in each second during the processing period of data recording function.

In the present embodiment, once the user finishes the definition of the reference data, the software may manually be switch into a background mode by pressing the background mode button or the user may switch the software to verifying mode by press the verifying test button. However, the mode switching process may also be automatically done by a certain procedure controlled by the CPU. During the background mode, the software shall not operate. However, once the user interface U1 is locked, the software shall be switched into a verifying mode automatically.

In the verifying mode, the software may provide a data verifying function, which is capable of recording a motion by the user by sensing or detecting the acceleration and orientation by acceleration sensor 30 and orientation sensor 50 so as to form a verifying data as previously described, the reference data and the verifying data will be calculated and compared thereafter so as to control a functional module 60 to perform a pre-determined function. In the present embodiment, the pre-determined function is capable of unlocking the user interface U1 and allowing the user to access the operation system.

After the definition of the reference data, the user may activate the pre-determined function by waving the mobile phone again using the same motion as the reference data. Then, the acceleration sensor 30 and the orientation sensor 50 of the mobile phone shall detect the motion of the user and generate a reference data formed of a plurality of subsequent acceleration factors and orientation factors and the reference data shall be stored into the memory 10 for the comparison. Then, the CPU 40 shall automatically obtain the reference data and the verifying data from the memory 10 and compares the said data thereafter so as to generate a corresponding controlling signal.

More specifically, when the reference data is determined by CPU 40 to be unmatched to the verifying data, then the functional module 60 shall not be activated, in contrast, the functional module 60 shall be turned on or activated by the controlling signal (ON signal) so as to perform the pre-determined function.

Furthermore, the means of comparing the reference data and the verifying data can either be though a proportional ratio method or a multi-stage verifying method. The proportional ratio method is to analyze if the consistency between the reference data and the verifying data reach a pre-determined pass threshold ratio. For example, while the consistency between the reference data and the verifying data is more than a pre-determined threshold ratio of 60%, then it passes the test, otherwise, it fails. Rather than comparing the whole verifying data, the multi-stage verifying method divides the verifying data into a plurality of portions by a pre-determined time length. Only the first portion of the verifying data passes the test and the next portion shall go on so as to minimize the reaction time and amount of the data required to be processed.

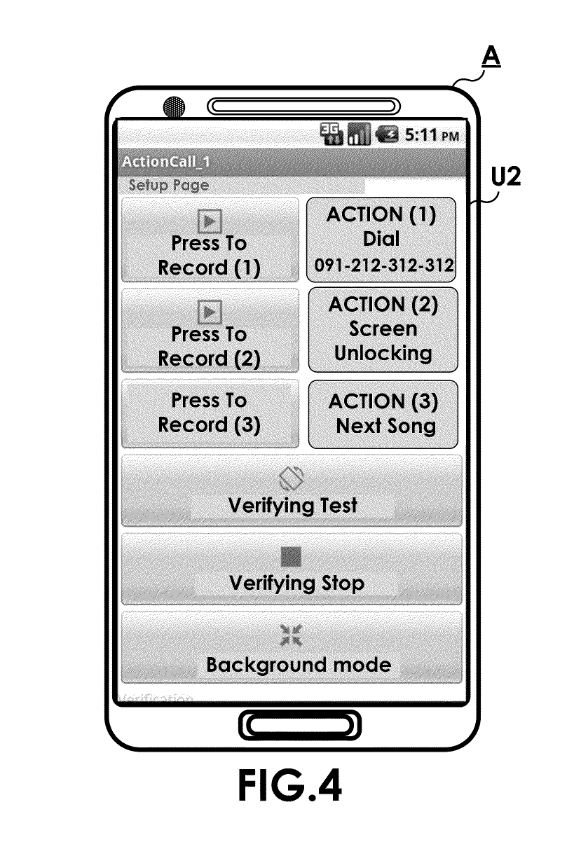

Furthermore, while in actual practice, the device may comprise more than one functional module 60, while each of the functional module 60 or the pre-determined function may be respectively corresponded to a pre-determined reference data. For example, while the user executes a U shaped motion, the functional module 60 shall automatically sends an SMS message to user A, while the user executes a C shaped motion, the functional module 60 may activate the camera accordingly. Furthermore, the pre-determined function and the motion can be configured by the user himself in accordance with the requirement thereof as depicted by FIG. 4.

In summary, the electronic device and the controlling method thereof of the present invention allow users to define a custom three dimensional action as an activation command of a pre-determined function.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A controlling method of an electronic device, comprising the following steps of:
automatically obtaining a reference data from a memory of an electronic device, the reference data comprising a plurality of acceleration factors, each of the plurality of acceleration factors comprising a plurality of acceleration vector data and a plurality of acceleration dimension data;
automatically obtaining a verifying data from the memory, the verifying data having a plurality of acceleration factors, each of the plurality of acceleration factors comprising a plurality of acceleration vector data and a plurality of acceleration dimension data;
automatically comparing the reference data with the verifying data so as to generate a control signal by a CPU of the electronic device; and
automatically activating a pre-determined function of the electronic device in accordance with the control signal.

2. The method of the claim 1, wherein the reference data is generated by an acceleration sensor of the electronic device in accordance with the acceleration applied to the electronic device.

3. The method of the claim 1, wherein the verifying data is generated by an acceleration sensor of the electronic device in accordance with the acceleration applied to the electronic device.

4. The method of the claim 1, wherein the reference data and the verifying data respectively comprise a plurality of subsequent orientation factors, each of the plurality of the orientation factors comprises a plurality of orientation vector data and a plurality of orientation dimension data.

5. The method of the claim 1, wherein the pre-determined function is a user interface unlocking function.

6. An electronic device, comprising:
a display, utilized to display a user interface;
an acceleration sensor, utilized to sense the acceleration of the electronic device;
a functional module, utilized to provide a pre-determined function;
a memory, utilized to store an interface data and a verifying procedure data, the interface data comprising a user interface, the verifying procedure data comprising the following procedures of:
obtaining a reference data, the reference data comprising a plurality of acceleration factors and being generated by the acceleration sensor;
obtaining a verifying data, the verifying data comprising a plurality of acceleration factors and being generated by the acceleration sensor;
comparing the reference data with the verifying data so as to generate a control signal; and
activating the pre-determined function in accordance with the control signal; and
a CPU, coupled with the display, the acceleration sensor, the functional module and the memory, the CPU utilized to operate the verifying procedure so as to activate the functional module while the reference data is matched with the verifying data.

7. The electronic device of the claim 6, wherein the reference data and the verifying data are defined by the user.

8. The electronic device of the claim 6, wherein the reference data and the verifying data respectively comprise a plurality of subsequent acceleration factors, each of the plurality of the acceleration factors comprises a plurality of acceleration vector data and a plurality of orientation dimension data.

9. The electronic device of the claim 6, wherein the reference data and the verifying data respectively comprise a plurality of subsequent orientation factors, each of the plurality of the orientation factors comprises a plurality of orientation vector data and a plurality of orientation dimension data.

10. The electronic device of the claim 6, wherein the pre-determined function comprises a user interface unlocking function which is capable of unlocking the user interface.
